(19) United States
(12) Patent Application Publication
(10) Pub. No.: US 2015/0358482 A1
(43) Pub. Date: Dec. 10, 2015

(54) SOURCE SELECTION FOR SHARED NETWORK CONNECTIVITY

(71) Applicant: Karma Mobility Inc., New York, NY (US)

(72) Inventors: Robert Schouwenburg, New York, NY (US); Steven Andrew van Wel, New York, NY (US); Stefan Borsje, Noord-Holland (NL); Jan Leendert Hecker, Rotterdam (NL)

(73) Assignee: Karma Mobility Inc., New York, NY (US)

(21) Appl. No.: 14/295,423

(22) Filed: Jun. 4, 2014

(51) Int. Cl. H04M 15/00; H04W 40/24; H04W 12/06

(52) U.S. Cl. CPC H04M 15/8061; H04W 12/06; H04W 40/248

(57) ABSTRACT

A device such as a wireless access point may be configured to support sharing of network connectivity among a number of registered devices or users. Where numerous sources of network connectivity are available, the device may apply a cost-based selection strategy or the like to choose a suitable source for sharing.

### RELATED APPLICATIONS

This application is related to U.S. patent application Ser. No. 13/830,728 filed on Mar. 14, 2013, which claims the benefit of U.S. Prov. App. No. 61/754,995 filed on Jan. 22, 2013, the entire content of each of the foregoing is hereby incorporated by reference.

### FIELD OF THE INVENTION

This document generally relates to source selection for network connectivity sharing.

### BACKGROUND

Techniques have been devised for wirelessly sharing network connectivity among multiple registered users. When multiple sources of such connectivity are available, there remains a need for improved techniques for selecting from among these multiple sources.

### SUMMARY

A device such as a wireless access point may be configured to support sharing of network connectivity among a number of registered devices or users. Where numerous sources of network connectivity are available, the device may apply a cost-based selection strategy or the like to choose a suitable source for sharing.

In one aspect, a device includes a first interface configured to provide a wireless access point, and a second interface configured to couple in a communicating relationship with a number of sources of network connectivity to a data network. The device further includes processing circuitry configured to select a low-cost one of the sources of network connectivity as a network source for connectivity provided through the wireless access point. The processing circuitry may be further configured to selectively share the network source through the wireless access point with one or more predetermined users authenticated by the device through a remote resource.

In another aspect, a method includes searching for a number of sources of network connectivity to a data network, and identifying a low-cost one of the sources of network connectivity, thereby providing a selected network source. The method further includes operating a wireless access point, receiving a request for connectivity from a user through the wireless access point, and accessing a remote resource to determine whether the user is one of a number of predetermined users. When the user is one of the predetermined users, the method may also include sharing the selected network source with the user for connecting to the data network.

In yet another aspect, a computer program product for operating a wireless device including non-transitory computer executable code embodied in a non-transitory computer readable medium that, when executing on one or more computing devices, may control the wireless device to perform the steps of: searching for a number of sources of network connectivity to a data network, and identifying a low-cost one of the sources of network connectivity, thereby providing a selected network source. The computer program product may also control the wireless device to perform the steps of: operating a wireless access point; receiving a request for connectivity from a user through the wireless access point; accessing a remote resource to determine whether the user is one of a number of predetermined users; and, when the user is one of the predetermined users, sharing the selected network source with the user for connecting to the data network.

### BRIEF DESCRIPTION OF THE FIGURES

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a platform for portable bandwidth.

FIG. 2 shows a signal flow for connecting a client to a data network through a device as described above.

FIG. 3 shows an account dashboard for use at a client device.

FIG. 4 shows a process for operating a server to provide portable bandwidth.

FIG. 5 shows a method for sharing bandwidth.

FIG. 6 is a flow chart illustrating a method for selecting sources for network sharing.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” and the like, are words of convenience and are not to be construed as limiting terms.

Described herein are devices, systems, and methods of source selection for network connectivity sharing.

The systems and methods described below support various features and functions for managing portable bandwidth. In general, a predetermined user, such as a user having an account with a bandwidth management system, may consume bandwidth from a bandwidth account by logging in through any participating router or similar device.

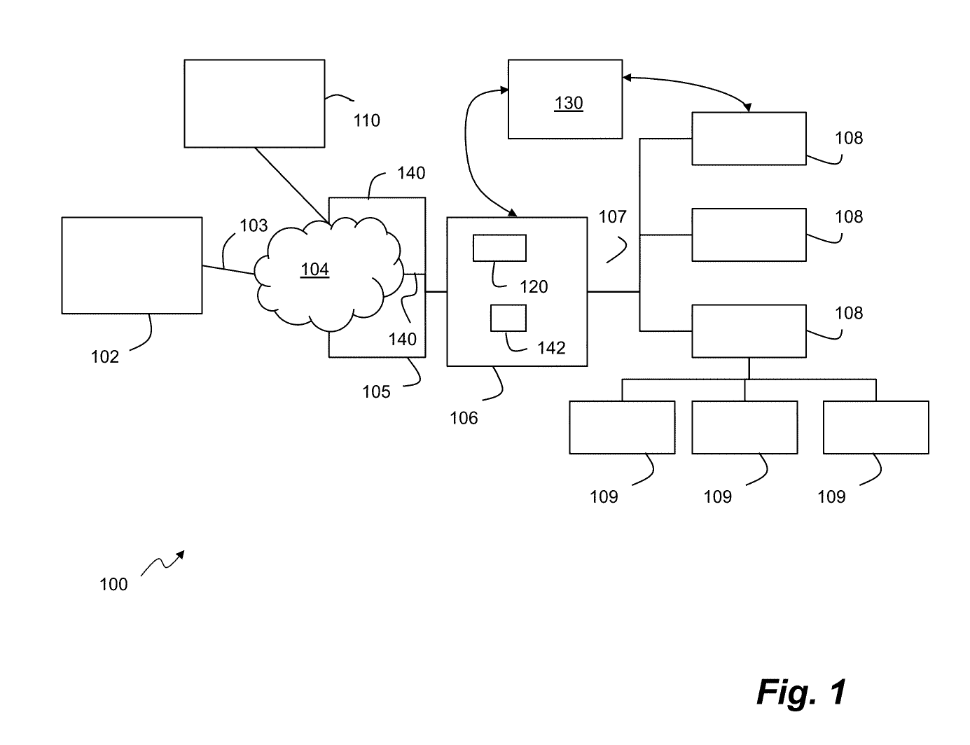

FIG. 1 shows a platform for portable bandwidth. In general, the system 100 may include a bandwidth management server 102, a data network 104, a device 106 for local distribution of bandwidth, and a number of clients 108 that are end users of clients.

The bandwidth management server 102 may in general maintain data usage allocation accounts (also referred to as “user accounts,” “allocation accounts” and the like, or simply “accounts”) for registered users. The accounts may be stored, e.g., in a database, with information concerning an allocation of data usage available for that user such as an available balance of data for use by the user on the data network 104. The bandwidth management server 102 may receive information concerning data usage, e.g., from a device 106 that is providing connectivity to clients 108, and may debit allocation accounts accordingly. When an allocation has been depleted, the server 102 may transmit an instruction to the device 106 to terminate connectivity for a corresponding one of the clients 108, or to request payment for an additional data usage allocation, which instruction may be processed by the device 106 in order to take corresponding action.

The server 102 may also provide supporting functions. For example, the server 102 may provide a dashboard for individual end users to monitor account status, view current usage information (such as current devices using bandwidth under the account and related, current usage statistics), view account balances, purchase additional bandwidth, and so forth.

In operation, the server 102 may receive an indication of data usage by a user from the device 106 that provides connectivity for the data usage to the user (although users are not separately illustrated, it will be appreciated that each user operates one or more client devices, or simply clients 108) and update a corresponding data usage allocation account appropriately. When a data usage allocation account is at or below zero, the server 102 may send a corresponding notification to the device 106 providing connectivity so that the device 106 can take appropriate local action.

Operation of the device 106 may be incentivized by providing a reward to an operator of the device 106. For example, when a user accesses the device 106 with a client device 108 for connectivity to the data network, the account of the operator at the server 102 may be credited with a supplemental data usage allocation so that the operator can enjoy additional data usage on the data network 104 without pay. While a single server/device/client interaction has been described, the system 100 may be readily adapted to multi-party use. So for example the server 102 and the device 106 may be configured to manage connectivity to multiple clients 108 for a single user through the device 106 or through multiple devices 106, and to similarly manage connectivity for multiple users. Similarly, the server 102 may be configured to manage data usage allocation accounts for a plurality of users, and to manage a plurality of devices 106 that provide connectivity to clients 108.

Further, the server 102 may receive device-initiated updates from the device 106 concerning data usage by connected clients 108, or the server 102 may request updates on data usage from the device 106. In general, the server 102 preferably awaits updates from devices 106 in order to relieve the server 102 of any polling or similar repetitive overhead activity. However, the server 102 may from time to time transmit update requests, particularly where irregularities in data usage are detected or where a particular user has a low balance in an account.

The server 102 may include an interface 103 to the data network 104, which may be any network for communicating data among devices including without limitation the internet and/or any cable networks, telecommunications networks, cellular telephony networks and the like, along with any access points, local area networks, and the like providing last-mile infrastructure to couple the data network 104 in a communicating relationship with the device 106, as well as any combinations of the foregoing. The server 102 may include or be associated with a connectivity service provider (such as a telecommunications company, cellular company, or independent infrastructure operator or provider) that provides network connectivity to or through the data network 104 to the device 106 for the data usage. The server 102 may also or instead maintain multiple commercial relationships with multiple connectivity service providers.

The device 106 may in general serve as an access point, wireless access point, or router for providing local connectivity that is managed by the server 102. The device 106 may include hardware and software for a variety of related functions. For example, the device 106 may include a communication interface for coupling to and communicating through the data network 104. The device 106 may also include a wireless and/or wired interface for coupling with clients 108 and providing connectivity thereto. The device 106 may include a router or similar hardware/software to manage multiple connections with the clients 108 (which may include clients 108 associated with an owner or operator of the device 106). The device 106 may also include hardware/software to instrument the usage of data by the clients 108, which may be reported back to the server 102 on a client-by-client basis so that the server 102 can manage account balances accordingly. The device 106 may also include a web server or the like for presenting login and account management pages to clients 108 when they initially connect to/through the device 106, and/or when a bandwidth allocation is depleted and one of the clients 108 must purchase additional bandwidth from the server 102. Terms such as router, wireless router, wireless access point, access point and the like as used herein are intended be used interchangeably to refer to any device that can provide connectivity to other devices, unless a more specific meaning is explicitly provided or otherwise clear from the context.

In general, the device 106 may include a first communication interface 105 configured to communicate using the data network 104 and a second interface 107 configured to communicate with one or more clients 108. Internally, the device 106 may operate a router 120 to manage connections by the one or more clients 108 to the data network 104 through the first communication interface 105 and the second communication interface 107, along with software configured to monitor a data usage over the first communication interface by each of the one or more clients, and to report the data usage to a server through the first communication interface. The device 106 may be a portable computing device such as a standalone device or a device integrated into a general purpose device such as a laptop computer, a smart phone, or a tablet.

The device 106 may be coupled to the server 102 through any suitable interface 105 that provides access to the data network 104. For example, the interface 105 may include a wireless network such as a cellular data network (e.g., a 3G network, a 4G network, an LTE network, a WiMax network, or any combination of these, or any other legacy cellular data networks). The interface 105 may also or instead include a wired connection including without limitation a connection using wired Ethernet (e.g. to a wired Ethernet local area network), a Digital Subscriber Line (DSL) modem, a cable modem, and the like, as well as any suitable optical interface(s) and connector(s).

While the device 106 may use the interface 105 to access the data network 104, one or more other communications interfaces 140 may also be available. Thus for example, where the interface 106 is an interface to a WiFi access point, the other communications interfaces 140 may include one or more other WiFi access points, cellular data network interfaces, wired interfaces, telephone connections, short range wireless data interfaces, and so forth. As contemplated herein, a processor 142 on the device 106 may be configured to evaluate the various interfaces 105, 140 available for accessing the data network 104, and to select one of the interfaces 105 as the interface for providing connectivity to the clients 108.

In one aspect, the device 106 may be a portable hotspot or similar device that is self-powered, and includes a cellular connection to a data network using, e.g., 3G/4G or any similar network. The device 106 may also include a WiFi air interface for coupling to the clients 108, and may broadcast any suitable SSID for ready identification. The device 106 may also include a web server (e.g., executing on the processor 142) for presenting a user interface on the clients 108 for various related tasks such as sign in, sign up, and connectivity purchases. While the device 106 may be a small, dedicated device for personal use, it will be appreciated that the device 106 may readily be deployed on other devices such as a wireless router, laptop computer, smart phone, or the like. The web page or other user interface (and the SSID) may be branded or otherwise configured as desired by an operator of the device 106 for easy identification by a potential user. The device 106 may connect to any number of clients 108 through a second interface 107. The second interface 107 may include any short range communications interface or combination of such interfaces.

The device 106 may include software executing on the processor 142 to measure traffic by individual users and to report this usage to the server 102 in a manner that permits individual accounting against data usage allocations. During each client session, the device 106 may, for example, periodically send traffic usage information to the server 102. When a data usage allocation for an account reaches zero, a notification may be sent from the server 102 to the device 106, and the device 106 may present a web page or similar user interface to the client notifying the client 108 of the zero balance and providing a user of the client 108 with an opportunity to purchase additional bandwidth.

In another aspect, the device 106 may track usage for multiple users or clients 109 that are connected through a WiFi hotspot or other network access point offered by a client 108 that is connected to the data network 102 through the device 106. In this aspect, a user may secure a network connection through the device 106 and share the connection as an access point with any number of other clients/devices. An account for the user of the device 106 providing the WiFi hotspot may be debited for the aggregate usage of all such devices. In another aspect, the user may share connectivity in the same manner as the device 106, i.e., such that other users/clients may access the data network 104 through the client device 108, but only after logging in to the server 102 with a separate account. In such a usage scenario, the client 108 that is providing such connectivity to another client 108 may receive or share credits for sign up, sign in, and/or usage for such other client 108 using any suitable allocation scheme. In another aspect, the client 108 may operate in a combination of these modes by providing connectivity to some clients 109 on its own account, and providing connectivity to other clients 109 on other user accounts.

A user's account may be managed through any suitable social networking platform 110. Thus, the user may login from a client 108 at the device 106 with the user's social network platform credentials, through which the user may access/manage an allocation of bandwidth at the server 102. This general approach may be implemented in a variety of ways to leverage pre-existing social networks to support a simplified usage protocol. In one aspect, the social network platform 110 may support access to the server 102 so that a user can access corresponding functionality through the social network platform 110. For example, user account information (e.g., credentials) for the server 102 may be stored in the social network platform 110 permitting seamless access through the social network platform 110. In a complementary fashion, the server 102 may also or instead store user account information (e.g., credentials) for the social network platform 110 so that the user can login to the server 102 using the social network credentials, or have the server 102 automatically access the social network platform 110 during use. In one aspect, a user may manage their user account by logging into the account without the need of a social networking platform 110—for example, a user may login with a username/password combination or other suitable credentials, or a user may manage their account through another platform, and so forth.

The clients 108 may in general include any client devices including without limitation laptop computers, desktop computers, cellular phones, smart phones, tablets, media players, personal digital assistants, or any other computing/communication device with a complementary communication interface and data networking needs.

In order to support the foregoing functionality, the device 106 may provide a user interface 130 for the clients 108. This may be presented as a single, continuous interface or as a sequence of different interfaces according to a desired user experience. While described below as a series of discrete interfaces, it will be readily appreciated that the sequential interfaces may be provided in the context of a single HTTP session, webpage, or application window. The interface 130 may in general be a web interface or HTML interface such as a webpage, along with any related active components, scripts, or the like, or the interface 130 may be an application executing on the device 106 or the client 108, or some combination of the foregoing.

The user interface 130 may be adapted to initiate new connections using the system 100. The software on the device 106 may for example be configured to present a first user interface to one of the clients 108 when the one of the client devices initiates a connection to the data network through the second communication interface. This first interface may be configured to obtain account information for a user of the one of the clients 108 to authorize usage of data network connectivity of the device 106, and the software of the device 106 may respond to an authorization to provide connectivity to the client 108 (from the server 102) by providing a connection for the client 108 to the data network 104.

The user interface 130 may also be adapted to interactively request additional usage purchases when an account is depleted. The software on the device 106 may be further configured to present a second user interface to the client 108 when the server 102 provides an indication that the user of the client 108 does not have an available allocation of data usage. The second user interface may also be configured to transfer payment information from the user to the server 102 (which is intended in this context to include transferring payment information to a payment processing platform used by the server 102) to add a data usage allocation to an account for the user. The software may then respond to an approval from the server 102 by providing additional connectivity to the client 108.

In one aspect, the allocated data usage is portable. That is, the data usage may be consumed from any device, and a user may move from device to device, or use multiple devices concurrently by logging in with suitable credentials from each such device on which a user wishes to have network connectivity. In another aspect, the system provides simultaneous or concurrent use of connectivity from a single user account on multiple devices. The data usage is deducted from an account of the user, which account contains a quota for the user based upon data usage purchased or otherwise received by the user for consumption. As noted above, the data usage allowance may be associated with a social network account for the user, which may be an account for a social network platform supported by the bandwidth management system, or an independent social network supported by any other social network platform.

As noted above, connectivity sharing may be incentivized with rewards of data usage allowances to devices, or operators of devices, that provide connectivity. In one aspect, an operator may receive a reward the first time that a client 108 connects to the data network 104 through the device 106. This may be when the client 108 signs up for a new account through the device 106, or when the client 108 accesses the data network 104 through the device 106 for a first time with a pre-existing account. When a user at a client 108 has consumed all allocated data usage, the user may be directed by the device 106 to a web page or similar interface where the user can purchase an additional allocation of bandwidth.

Local communications between end users at clients 108 and the device 106 may be maintained using any suitable interface and/or communications standards (the hardware and software of which is referred to collectively herein as a communication interface), such as a WiFi interface. While WiFi or other 802.11 wireless communications standards are a preferred medium for maintaining short-range wireless communications with participating clients, it will be appreciated that a variety of suitable short-range standards and techniques may also or instead be employed including without limitation frequency modulation (FM), BlueTooth, and the like, which may advantageously use unlicensed spectrum to avoid interference with licensed users.

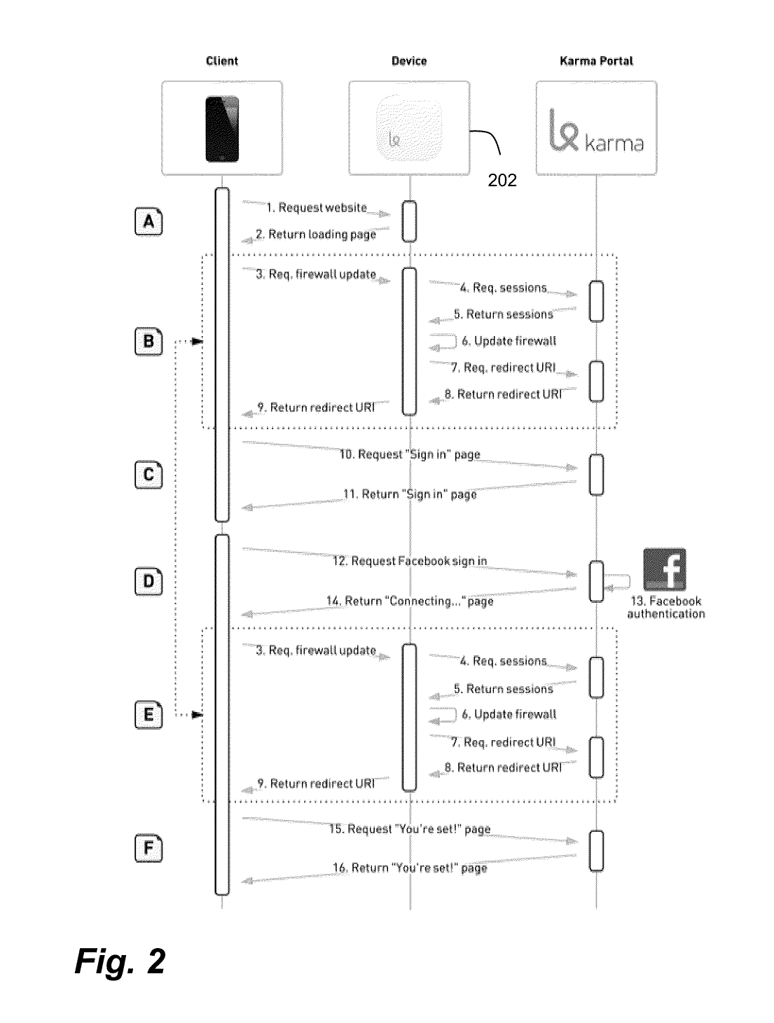

FIG. 2 shows a signal flow for connecting a client to a data network through a device as described above. In general, a process for initiating such a connection may include the following, which provides an exemplary connection through a “Karma” router and suggests several steps, although it will be appreciated that the specific details below are optional, and various other implementations will be readily appreciated by one of ordinary skill in the art.

In a first step, A, a web page 202 may be presented from a device such as any of the devices described above to a client in response to a connectivity-related request. Initially, this web page 202 may initially be a loading page such as a graphic or the like, although the web page 202 and the corresponding user interface displayed on the client may be adapted throughout an interaction according to a current state of the client and an account for the client (or lack of an account) on the server. Details of the web page 202 are omitted, and will be readily appreciated by one of ordinary skill in the art.

In Step A, a user instructs the client to request a website, such as any third party website, using, e.g., a Uniform Resource Locator or IP address. The device may detect the user hasn't authenticated yet, and return a loading page instead of the requested website. The initial page may instead be provided in response to selection of the device as a WiFi or other network resource for connectivity. For example, if the user searches for WiFi networks, the device may appear as available and the user may select the device. Once the user is connected to the Wi-Fi resource, the user may be directed to the web page 202 (either explicitly by selection of the device, or implicitly by entry of a URL, URI or the like).

The web page 202 may initially inform the user that a connection is being set up. The device may then interactively take a number of steps to complete the connection setup.

In step B, the device may interactively update a firewall for the client to facilitate managed network connectivity. Although such setup is infrastructure dependent, this may generally include providing Medium Access Control address information and session identification information to the client for the creation of a secure connection to an Application Programming Interface of the device. This may permit the creation of a secure HyperText Transfer Protocol (HTTP) session for secure communications between the device and the client. In one aspect, if there is no secure HTTP session (or creation of same), the user may be redirected from the web page in order to force the client to create a secure HTTP session.

In step C, the resulting secure connection can be used to present a sign-in page to the client, e.g., with suitable modifications to or replacement of the web page 202. The sign-in page may provide information about the services offered by the device, and about the operator of the device. The sign-in page may also provide a link to a page for receiving such credentials.

In step D, the client may be redirected to a page for providing credentials to receive connectivity through the device. This may, for example, include credentials for a bandwidth allocation server (e.g., e-mail and password or other suitable credentials), or this may include credentials for a social network platform through which such services are managed. For example, the system may use the Facebook OAuth procedure to receive Facebook credentials. The client may provide corresponding credentials and be redirected to a splash page or the like while the credentials are authenticated. The user may also be asked to approve the use of the social network platform to access user information in the social network platform.

As shown in step E, once the connectivity has been authorized for the user, the firewall for the client device operated by the user may be updated. This may in general follow the procedure outlined in step B, except that flow is initiated from a webpage hosted by the remote resource and results in a webpage or message presented on the client that the connection is active. The remote resource may be a remote processing resource such as a server or the like.

In step F, the client may request a confirmation page, e.g., by redirection from the server-initiated web page, in order to force the client to check internet connectivity.

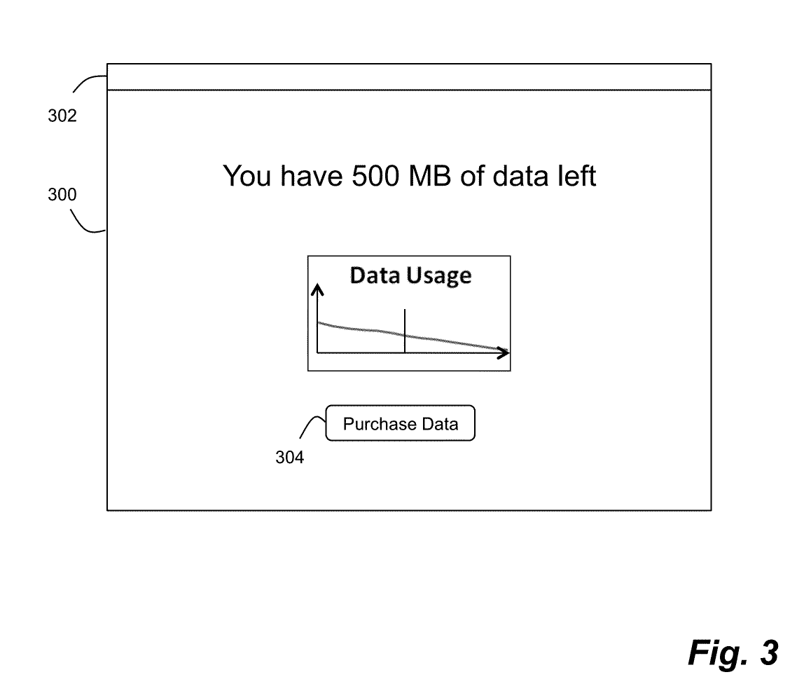

FIG. 3 shows a dashboard for a client device to monitor an account. The dashboard 300 may be a web-based dashboard (such as an HTML page) provided by the server and/or device through the data network or the dashboard may be an application executing on the client. In general, the dashboard may provide information concerning a user account such as settings, billing information, billing history, device information, and a balance in the user's data usage allocation account, along with usage history and the like. Other information relating to the client device may be presented in a status bar 302 such as an SSID of a device through which the client is connected, battery status and signal status. The data for this section may be loaded e.g., through an asynchronous HTTP GET request to a JSON endpoint or JSON-P endpoint on the device.

Thus in one aspect, the device described herein may include software configured to present a user interface to a client providing account management information about the client. Account management information may include any useful information such as a data usage allocation in the account for the user. The user interface may also provide a purchasing interface 304 for a user to add additional data usage allocation to an account.

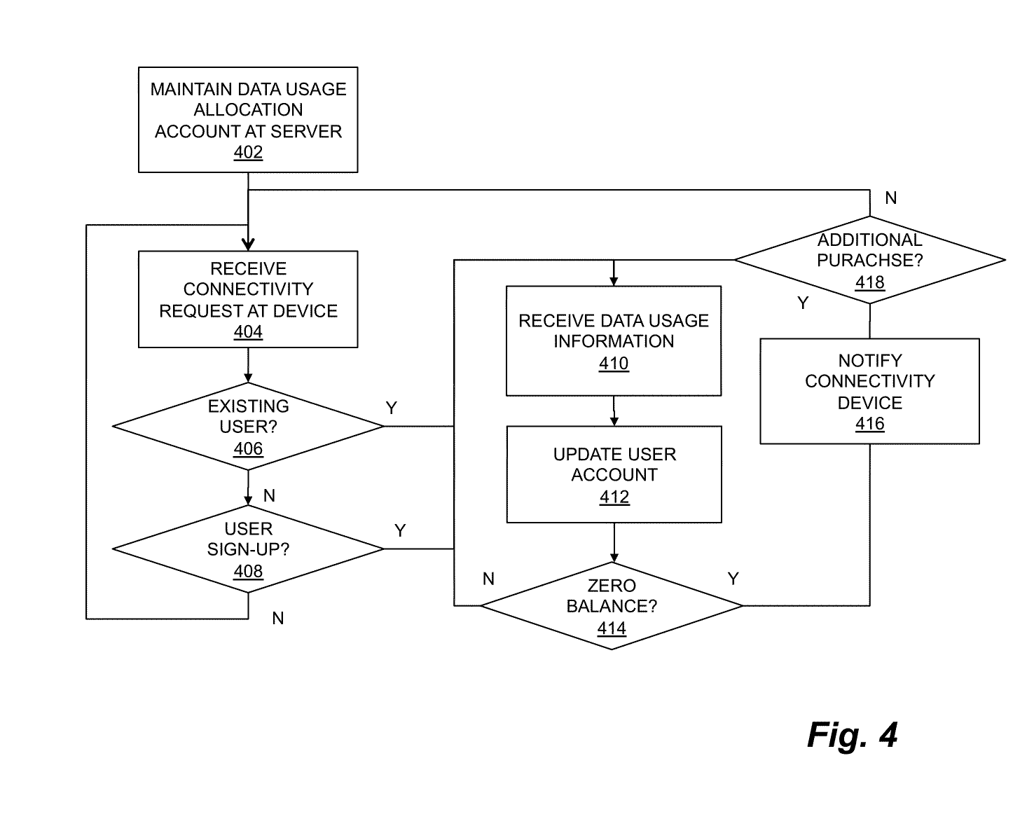

FIG. 4 shows a process for operating a server to provide portable bandwidth.

As shown in step 402, the process 400 may begin with maintaining a data usage allocation account for a user that includes an available balance of data for use by the user on the data network. The account may be created generally as described above, or in some independent web interaction between a user and the server. The account may be stored at the server in any suitable form, such as in a relational database or the like.

As shown in step 404, the process 400 may include receiving a connectivity request at a device such as any of the devices described herein.

As shown in step 406, it may be determined if the user is an existing user, in which case the user may be authorized to use the device and the process 400 may proceed to step 410 where usage can be monitored. If the user is accessing the device for the first time, e.g., with a pre-existing data usage allocation account, then the account of the operator of the device may be credit with a supplemental data usage allocation for use by the operator.

As shown in step 408, where the user is not an existing user, a user sign-up procedure for connectivity services may be initiated. If the sign-up process is completed, the user may be authorized and the process may proceed to step 410 where usage can be monitored through the device. When a user signs up for a new data usage allocation account through the device, the account of the operator may be credited with a supplemental data usage allocation for use by the operator. If the sign-up process is not completed, the process 400 may return to step 404.

As shown in step 410, the process 400 may include receiving an indication of data usage by the user from the device that provides connectivity. The user may connect to the device with any of the clients described above, and the device may be any of the devices described above. The indication of data usage may, for example, identify the user and an amount of the data usage, and provide any other useful information for data usage accounting as contemplated herein. When the user accesses the device with a client for connectivity to the data network, the process 400 may include crediting an account of an operator of the device with a supplemental data usage allocation under certain conditions, such as when the user connects through the device for the first time.

As shown in step 412, the process 400 may include updating the user account according to the received information, such as by subtracting the amount of the data usage from the data usage allocation account for the user.

As shown in step 414, the process may include checking if the account balance for the user is above zero. When the balance is above zero, the process 400 may return to step 404 to continue monitoring data usage by the user. When the balance is at or below zero, the process 400 may proceed to step 410

As shown in step 416, when the balance in the account for a user is at or below zero, the process 400 may include sending a notification to the device.

As shown in step 418, the device may locally process this notification in a number of ways. If the user at the client purchases additional data usage, the process 400 may return to step 410 where usage is monitored. If the user at the client does not purchase additional data usage, then the client may be disconnected and the process 400 may return to step 404 where the device awaits a new connectivity request.

In general, while illustrated as a single, discrete process, the process in FIG. 4 may be executed concurrently, sequentially, or some combination of these for a number of clients receiving connectivity through a device. Thus the device may receive indications of data usage for the user from a plurality of clients (e.g., different devices) coupled in a communicating relationship to the device, or the device may receive indications of data usage from a plurality of users (e.g., different accounts) coupled in a communicating relationship to the device, or any combination of these. Similarly, the server that maintains data usage allocation accounts may maintain accounts for any number of users.

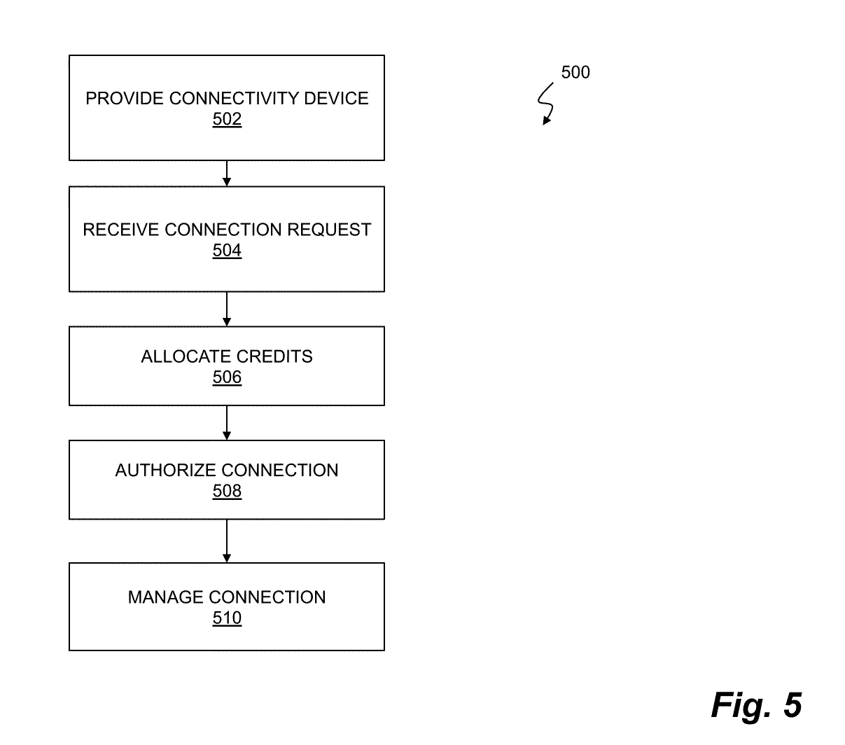

FIG. 5 shows a method for sharing bandwidth.

As shown in step 502, the method 500 may include providing a device that supports data connectivity to one or more clients. This may for example be any of the devices described herein.

As shown in step 504, the method 500 may include receiving a connection request, such as a request to obtain connectivity to a data network through the device from a client or a request to sign up for a managed data usage account.

As shown in step 506, the method 500 may include allocating credits as appropriate based upon the client access. This may include conditionally crediting an account of an owner of the device with an additional data usage allocation when the client connects to the device for a first time for data connectivity This may also or instead include conditionally crediting the account when a user of the one of the clients purchases a data usage allocation for the connectivity to the data network.

As shown in step 508, the method 500 may include authorizing a connection for the client to a data network through the device. For example, the method 500 may include presenting a user interface to one of the clients, the user interface configured to request credentials from the one of the clients to use the data connectivity. As noted above, the credentials may be for an external platform such as a social networking platform through which a corresponding account is managed. The method 500 may also or instead include transmitting the credentials to a remote resource and receiving authorization information from the remote resource based upon the credentials. The method 500 may also or instead include receiving connectivity authorization information for the client from the remote resource such as the bandwidth management server described above, upon which authorization the requested connection.

As shown in step 510, the method 500 may also or instead include managing such a connection in various ways. For example, the method 500 may include transmitting data usage information for one of the clients to a remote resource in order for the remote resource to maintain an account balance for the user. This may also include transmitting current account data to the user for review. In one aspect, the method 500 may include presenting a user interface to one of the clients, the user interface configured to notify the one of the clients when a data usage allocation for a user of the one of the clients is zero. The user interface may be further configured for the user to purchase an additional allocation of data usage. More generally, any account management or maintenance information may be transmitted between the remote resource and the client that might be useful to manage the connection or provide information to the user about one or more accounts.

Devices, systems, methods, and techniques of source selection for network connectivity sharing will now be discussed.

In one aspect, a device may be provided that includes features of source selection for network connectivity sharing. The device may include any suitable device including without limitation any of the devices described above.

The device may include a first interface configured to provide a wireless access point. The first interface may include any suitable interface including without limitation any of the types of interfaces described above. For example, the first interface may include the interface 105 described with reference to FIG. 1. The wireless access point may include a WiFi access point or the like.

The device may also include a second interface configured to couple in a communicating relationship with a number of sources of network connectivity to a data network. The second interface may include any suitable interface including without limitation any of the types of interfaces described above. For example, the second interface may include the interface 107 described with reference to FIG. 1. The number of sources of network connectivity may include without limitation a public WiFi access point, a secured WiFi access point, a subscription-only WiFi access point (e.g., Boingo, Gogo Inflight, etc.), a cellular data network, or the like.

The device may further include processing circuitry configured to select a low-cost one of the sources of network connectivity as a network source for connectivity provided through the wireless access point. In one aspect, the processing circuitry will select the lowest-cost option from the sources of network connectivity as the network source for connectivity. In another aspect, the processing circuitry may list all of the low-cost options for a user to manually choose. In yet another aspect, the processing circuitry will use other criteria in addition to or instead of cost to select one of the sources of network connectivity as the network source, including without limitation signal strength, reliability, rating, source, and the like. The reliability, rating, and the like may be provided by user ratings and reviews, which may be available to users of the device. The processing circuitry may be further configured to selectively share the network source through the wireless access point with one or more predetermined users authenticated by the device through a remote resource. The predetermined users (or other users) may be able to add their own wireless network as one of the sources of network connectivity (i.e., a user may be able to add their own wireless network as an access point for the device). In this manner, a user may be able to share their wireless network as an access point for other (similar) devices, e.g., predetermined users' devices.

The remote resource may be configured to charge an account of one of the predetermined users connecting to the data network through the wireless access point. The remote resource may charge the account a fixed amount. The fixed amount may be based on the number of users connected. The remote resource may instead be configured to charge the account a variable amount depending on, e.g., a cost to the device of the network source, an amount of time that users are connected, or the like, or any combination thereof. The remote resource may maintain a data usage allocation account for each of the predetermined users. The remote resource may add a credit to an account of one of the predetermined users associated with the device with supplemental data usage allocation when a new user accesses the data network by connecting to the wireless access point through the device. The new user may be a user connecting to the wireless access point of the predetermined user for the first time, or connecting to any wireless access point of the system for the first time. The remote resource may also or instead add a credit to an account of one of the predetermined users associated with the device with supplemental data usage allocation when a new user creates a data usage allocation account with the remote resource through the wireless access point.

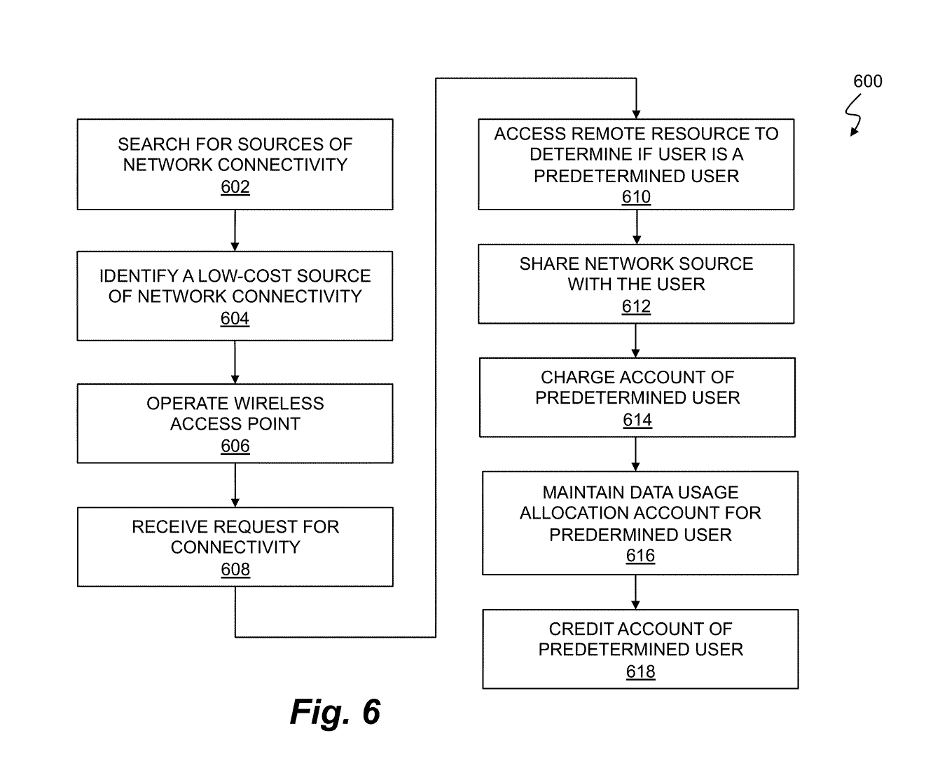

FIG. 6 is a flow chart illustrating a method for selecting sources for network sharing. The method 600 may include cost-based selection of a network source from among numerous possible sources.

As shown in step 602, the method 600 may include searching for a number of sources of network connectivity to a data network. The search may take place using any of the devices and systems described above or any other suitable means. The number of sources of network connectivity may include a public WiFi access point, a secured WiFi access point, a subscription-only WiFi access point (e.g., Boingo, Gogo Inflight, etc.), or any other IEEE 802.11-based network, IEEE 802.16-based network (e.g., WiMax), or the like. In addition cellular data networks such as any of those described herein may also or instead be used as sources of network connectivity, as may any of a variety of standardized or proprietary ad hoc wireless networks. More generally, sources of network connectivity may include any one or more sources of access to a data network that might be usefully shared with clients as contemplated herein. In one aspect, the number of sources of network connectivity may include a wireless network provided by one or more predetermined users (or other users of the systems described herein) such as a private or public home network, a private or public office or other institutional network, a subscription-based network, or the like.

As shown in step 604, the method 600 may include identifying a low-cost one of the sources of network connectivity. In one aspect, the identified low-cost source of network connectivity may be selected by processing circuitry or the like, thereby providing a selected network source. The identified low-cost source of network connectivity may be the lowest-cost option out of the number of sources of network connectivity uncovered by the search of step 602. In one aspect, a costing algorithm as contemplated herein explicitly relies on an actual fiscal cost, such as a subscription fee for securing connectivity through a network source, or data usage charges incurred through the network source, or some combination of these. Cost may also or instead include any metric or figure of merit that might be objectively determined in association with various network sources. For example, cost may include a power usage cost for a client device or for the device providing network connectivity. Cost may also or instead include administrative costs such as any overhead associated with securing access to the network. Other costs or objective measures of desirability of a network source may include, without limitation, data rates, latency, firewall or other networking restrictions, and so forth. Whatever metric(s) are used, a corresponding algorithm may be readily created by one of ordinary skill in the art to determine a low-cost one (or more) of the available network sources for use in providing connectivity.

As shown in step 606, the method 600 may include operating a wireless access point. The wireless access point may be a WiFi access point or any other wireless communication interface described herein or otherwise suitable for use in providing connectivity as contemplated herein.

As shown in step 608, the method 600 may include receiving a request for connectivity from a user through the wireless access point. The user may selectively send the request, e.g., by explicitly selecting the device from a list of available networks or otherwise attempting to use the wireless access point, or implicitly by entry of a URL, URI, or the like.

As shown in step 610, the method 600 may include accessing a remote resource to determine whether the user is one of a number of predetermined users. A predetermined user may be a user of the remote resource, such as a user having an account with a bandwidth management system as described above. The account may be created and administered generally as described above, or in some independent web interaction between a user and the remote resource. The account may be stored at the remote resource in any suitable form, such as in a relational database or the like.

As shown in step 612, the method 600 may include sharing the selected network source with the user so that the user can connect to the data network, e.g., when the user is one of the predetermined users. If the user is not one of the predetermined users, e.g., if the user is accessing the device (or the more general connectivity sharing service) for the first time, a user sign-up procedure for connectivity services may be initiated. If the sign-up process is completed, the user may be authorized and the selected network source may be shared with the user for connecting to the data network. When a user signs up for a new account through the device, the account of the operator may be credited with a supplemental data usage allocation for use by the operator of the device, or otherwise rewarded as contemplated herein. In this manner, the operator may be incentivized to share access to the data network.

As shown in step 614, the method 600 may include charging an account of one of the predetermined users at the remote resource for connecting to the data network through the wireless access point. In one aspect, the account of one of the predetermined users may be charged a variable amount depending on a cost of securing connectivity through the selected network source. That is, where the costing mechanism is financially based, the amount charged to the user may be determined based in whole or in part upon the actual cost of securing connectivity, the number of users employing the connectivity, and any other factors affecting the financial costs associated with the connection.

As shown in step 616, the method 600 may include maintaining a data usage allocation account at the remote resource for each of the predetermined users.

As shown in step 618, the method 600 may include crediting an account of one of the predetermined users associated with the wireless access point with supplemental data usage allocation at the remote resource when a new user connects to the wireless access point through the device. The method 600 may also or instead include crediting an account of one of the predetermined users associated with the device with supplemental data usage allocation when a new user creates a data usage allocation account with the remote resource through the wireless access point.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A device comprising:
a first interface configured to provide a wireless access point;
a second interface configured to couple in a communicating relationship with a number of sources of network connectivity to a data network; and
processing circuitry configured to select a low-cost one of the sources of network connectivity as a network source for connectivity provided through the wireless access point, the processing circuitry further configured to selectively share the network source through the wireless access point with one or more predetermined users authenticated by the device through a remote resource.

2. The device of claim 1 wherein the wireless access point is a WiFi access point.

3. The device of claim 1 wherein the number of sources of network connectivity include a public WiFi access point.

4. The device of claim 1 wherein the number of sources of network connectivity include a secured WiFi access point.

5. The device of claim 1 wherein the number of sources of network connectivity include a subscription-only WiFi access point.

6. The device of claim 1 wherein the number of sources of network connectivity include a cellular data network.

7. The device of claim 1 wherein the number of sources of network connectivity includes a wireless network provided by the one or more predetermined users.

8. The device of claim 1 wherein the remote resource is configured to charge an account of one of the predetermined users connecting to the data network through the wireless access point.

9. The device of claim 8 wherein the remote resource is configured to charge the account a variable amount depending on a cost to the device of the network source.

10. The device of claim 8 wherein the remote resource maintains a data usage allocation account for each of the predetermined users.

11. The device of claim 10 wherein the remote resource adds a credit to an account of one of the predetermined users associated with the device with a supplemental data usage allocation when a new user accesses the data network by connecting to the wireless access point through the device.

12. The device of claim 1 wherein the low-cost one of the sources of network connectivity selected by the processing circuitry is a lowest-cost option from the number of sources of network connectivity.

13. A method comprising:
searching for a number of sources of network connectivity to a data network;
identifying a low-cost one of the sources of network connectivity, thereby providing a selected network source;
operating a wireless access point;
receiving a request for connectivity from a user through the wireless access point;
accessing a remote resource to determine whether the user is one of a number of predetermined users; and
when the user is one of the predetermined users, sharing the selected network source with the user for connecting to the data network.

14. The method of claim 13 wherein the wireless access point is a WiFi access point.

15. The method of claim 13 wherein the number of sources of network connectivity include a public WiFi access point.

16. The method of claim 13 wherein the number of sources of network connectivity include a secured WiFi access point.

17. The method of claim 13 wherein the number of sources of network connectivity include a subscription-only WiFi access point.

18. The method of claim 13 wherein the number of sources of network connectivity include a cellular data network.

19. The method of claim 13 wherein the number of sources of network connectivity includes a wireless network provided by one of the number of predetermined users.

20. The method of claim 13 further comprising charging an account of one of the predetermined users at the remote resource for connecting to the data network through the wireless access point.

21. The method of claim 20 further comprising charging the account a variable amount depending on a cost of securing connectivity through the selected network source.

22. The method of claim 13 further comprising maintaining a data usage allocation account at the remote resource for each of the predetermined users.

23. The method of claim 13 further comprising crediting an account of one of the predetermined users associated with the wireless access point with a supplemental data usage allocation at the remote resource when a new user accesses the data network by connecting to the wireless access point through the device.

24. The method of claim 13 wherein the low-cost one of the sources of network connectivity identified is a lowest-cost option from the number of sources of network connectivity.

25. A computer program product for operating a wireless device comprising non-transitory computer executable code embodied in a non-transitory computer readable medium that, when executing on one or more computing devices, controls the wireless device to perform the steps of:
searching for a number of sources of network connectivity to a data network;
identifying a low-cost one of the sources of network connectivity, thereby providing a selected network source;
operating a wireless access point;
receiving a request for connectivity from a user through the wireless access point;
accessing a remote resource to determine whether the user is one of a number of predetermined users; and
when the user is one of the predetermined users, sharing the selected network source with the user for connecting to the data network.

26. The computer program product of claim 25 further comprising code that performs the step of charging an account of one of the predetermined users at the remote resource for connecting to the data network through the wireless access point, wherein charging the account includes charging the account a variable amount depending on a cost of securing connectivity through the selected network source.
